(19) United States
(12) Patent Application Publication
(10) Pub. No.: US 2026/0136306 A1
(43) Pub. Date: May 14, 2026

(54) TRANSMIT POWER ACCUMULATION FOR PRACH TRANSMISSION IN CANDIDATE CELL IN L1 AND L2 MOBILITY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/120,704

(22) PCT Filed: Dec. 21, 2022
(86) PCT No.: PCT/CN2022/140567

§ 371 Date: Apr. 11, 2025

(51) Int. Cl. H04W 52/50; H04W 36/00; H04W 52/08; H04W 52/40

(52) U.S. Cl. CPC H04W 52/50; H04W 36/0072; H04W 52/08; H04W 52/40

(57) ABSTRACT

A method for wireless communication at a user equipment (UE) and related apparatus are provided. In the method, the UE sequentially receives, from a primary cell, multiple Physical Random-Access Channel (PRACH) requests for PRACH transmission. Each of the multiple PRACH requests includes a transmit power command (TPC) indicating an individual power for the PRACH transmission. The UE further transmits the PRACH transmission. The transmit power for the PRACH transmission is based on the individual powers of the multiple PRACH requests.

### TECHNICAL FIELD

The present disclosure relates generally to communication systems, and more particularly, to wireless communication with transmit power accumulation for PRACH transmission in candidate cell in L1 and L2 Mobility.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include memory and at least one processor coupled to the memory. Based at least in part on information stored in the memory, the at least one processor may be configured to receive, from a serving cell, an indication to transmit a Physical Random-Access Channel (PRACH) transmission to at least one candidate cell configured for layer 1 or layer 2 (L1/L2) inter-cell mobility and a transmit power command (TPC) for the PRACH transmission; and transmit the PRACH transmission to the at least one candidate cell using a transmit power based on the TPC.

In an aspect of the disclosure, a method, a computer-readable medium, and an apparatus are provided for wireless communication at a network entity. The apparatus may include memory and at least one processor coupled to the memory. Based at least in part on information stored in the memory, the at least one processor may be configured to provide an indication for a UE to transmit a PRACH transmission for at least one candidate cell configured for L1/L2 inter-cell mobility; and send, with the indication, a TPC indicating a transmit power for the PRACH transmission.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4 is a diagram illustrating an example cell configuration.

FIG. 5 is a diagram illustrating a system model of the special cell (SpCell) switch.

FIG. 6A and FIG. 6B are diagrams illustrating examples of power ramping for PRACH transmission in accordance with various aspects of the present disclosure.

FIG. 7 is a call flow diagram illustrating a method of wireless communication in accordance with various aspects of the present disclosure.

FIG. 8 is the first flowchart illustrating methods of wireless communication at a UE in accordance with various aspects of the present disclosure.

FIG. 9 is the second flowchart illustrating methods of wireless communication at a UE in accordance with various aspects of the present disclosure.

FIG. 10 is the first flowchart illustrating methods of wireless communication at a network entity in accordance with various aspects of the present disclosure.

FIG. 11 is the second flowchart illustrating methods of wireless communication at a network entity in accordance with various aspects of the present disclosure.

FIG. 12 is a diagram illustrating an example of a hardware implementation for an example apparatus and/or network entity.

FIG. 13 is a diagram illustrating an example of a hardware implementation for an example network entity.

FIG. 14A and FIG. 14B illustrate example aspects of PRACH transmissions, in accordance with various aspects of the present disclosure.

### DETAILED DESCRIPTION

Various aspects relate generally to wireless communication. Some aspects more specifically relate to the transmit power accumulation for PRACH transmission in candidate cell in L1/L2 mobility. In some examples, a UE may be configured to receive, from a serving cell, an indication to transmit a PRACH transmission to at least one candidate cell configured for L1/L2 inter-cell mobility and a TPC for the PRACH transmission. The UE may be further configured to transmit the PRACH transmission to the at least one candidate cell using a transmit power based on the TPC. In some aspects, the UE may be further configured to receive multiple PRACH requests indicating for the UE to transmit multiple PRACH transmissions to the at least one candidate cell, and the transmit power may be based on the accumulation of the TPCs of the multiple PRACH requests. Additionally, through DCI, the base station may indicate at least one of the start and the end of the accumulation of the TPCs, and the accumulation may be configured to be performed on one single beam or different beams.

Particular aspects of the subject matter described in this disclosure can be implemented to realize one or more of the following potential advantages. In some examples, by enabling the indication of PRACH transmission parameters and the power ramping for the transmit power through DCI, the described techniques can be used to reduce the latency of the PRACH transmission. Additionally, the DCI may further indicate at least one of the start and the end of the accumulation of the TPCs, and whether the accumulation to be performed on one single beam or different beams, which further improves the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

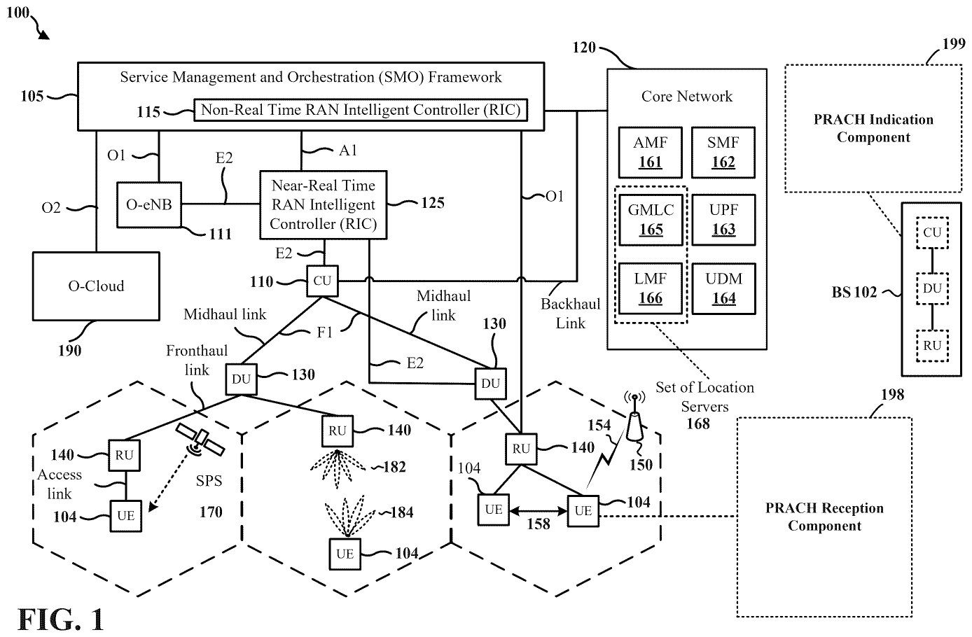

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, PRACH extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a PRACH Reception component 198. The PRACH Reception component 198 may be configured to receive, from a serving cell, an indication to transmit a PRACH transmission to at least one candidate cell configured for L1/L2 inter-cell mobility and a TPC for the PRACH transmission; and transmit the PRACH transmission to the at least one candidate cell using a transmit power based on the TPC. In certain aspects, the base station 102 may include a PRACH indication component 199. The PRACH indication component 199 may be configured to provide an indication for a UE to transmit a PRACH transmission for at least one candidate cell configured for L1/L2 inter-cell mobility; and send, with the indication, a TPC indicating a transmit power for the PRACH transmission. Although the following description may be focused on 5G NR, the concepts described herein may be applicable to other similar areas, such as LTE, LTE-A, CDMA, GSM, and other wireless technologies.

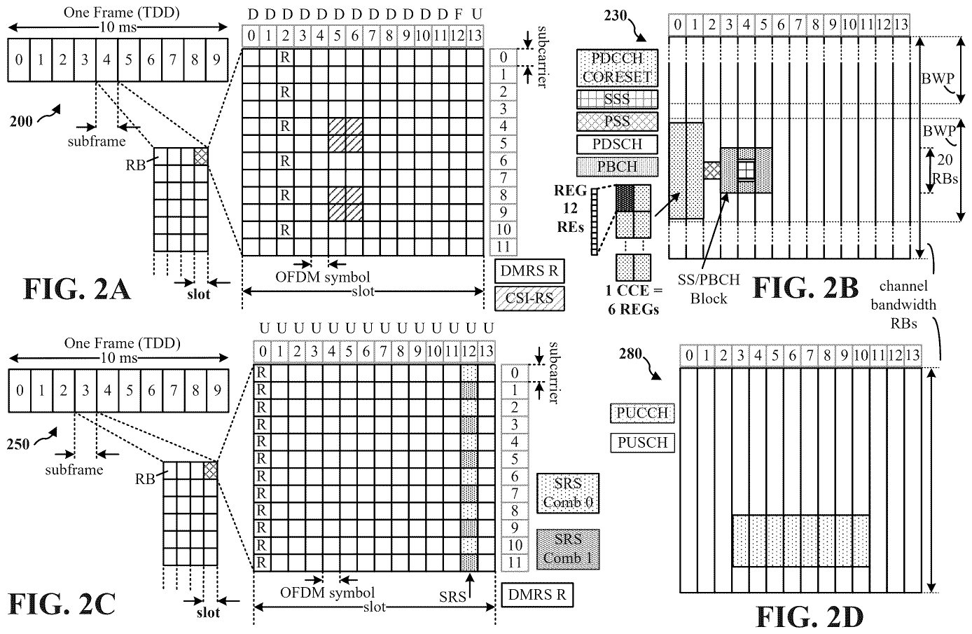

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

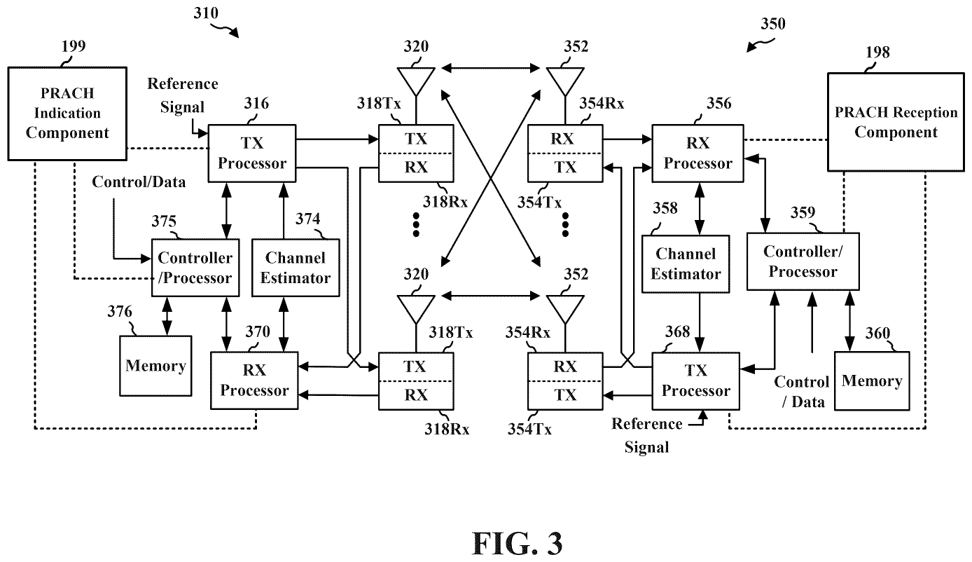

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PRACH reception component 198 of FIG. 1.

At least one of the TX processor 316, the RX processor 370, and the controller/processor 375 may be configured to perform aspects in connection with the PRACH indication component 199 of FIG. 1.

A network may configure a set of cells for layer 1 or layer 2 (L1/L2) mobility. The set of cells for L1/L2 mobility may be referred to as L1/L2 mobility configured cell set. A subset of the L1/L2 mobility configured cell set may be activated (e.g., with L1 or L2 control signaling) and may be referred to as an L1/L2 mobility activated cell set (which may also be referred to as an L1/L2 activated mobility cell set). The subset of cells in the L1/L2 mobility configured cell set that are not activated or that are indicated to be deactivated may be referred to as an L1/L2 mobility deactivated cell set or a deactivated L1/L2 mobility cell set. The L1/L2 mobility activated cell set may be a group of cells in the L1/L2 mobility configured cell set that are activated and may be readily used for data and control transfer. The L1/L2 mobility deactivated cell set (which may be an L1/L2 mobility candidate cell set) may be a group of cells in the configured set that are configured for the UE yet deactivated (e.g., not used for data/control transfer until activated) and may be activated by L1/L2 signaling. Once activated, a deactivated cell may be used for data and control transfer between a UE and a base station. The L1/L2 inter-cell mobility may reduce mobility latency. The configuration and maintenance of multiple candidate cells may allow for a quicker application of configurations for the candidate cells, and the activated set of cells may provide for dynamic switching among the candidate serving cells (e.g., including a SpCell and SCell) based on L1 or L2 signaling.

The procedures of L1/L2 based inter-cell mobility are applicable to many scenarios. These scenarios may include, but not limited to, standalone CA and NR-DC cases with serving cell changing within one CG, intra-DU cases and intra-CU inter-DU cases (applicable for standalone and CA, with no new RAN interface expected), intra-frequency and inter-frequency cases, FR1 and FR2 cases. In these scenarios, the source and target cells may be synchronized or non-synchronized.

For mobility management of the activated cell set, L1/L2 signaling may be used to activate/deactivate cells in the L1/L2 mobility configured cell set and to select beams within the activated cells (of the activated cell set). As the UE moves, cells from the L1/L2 mobility configured cell set may be deactivated and activated by L1/L2 signaling based on signal quality (e.g., based on measurements), loading, or the like. Example measurements may include cell coverage measurements represented by Radio Signal Received Power (RSRP), and quality represented by Radio Signal Received Quality (RSRQ), or other measurements that the UE performs on signals from the base station. In some aspects, the measurements may be L1 measurements, such as one or more of an RSRP, an RSRQ, a received signal strength indicator (RSSI), or a signal to noise and interference ratio (SINR) measurement of various signals, such as an SSB, a PSS, an SSS, a broadcast channel (BCH), a DM-RS, CSI-RS, or the like.

In some aspects, all cells in the L1/L2 mobility configured cell set may belong to the same DU and the cells may be on the same or different carrier frequencies. Cells in the L1/L2 mobility configured cell set may cover a mobility area.

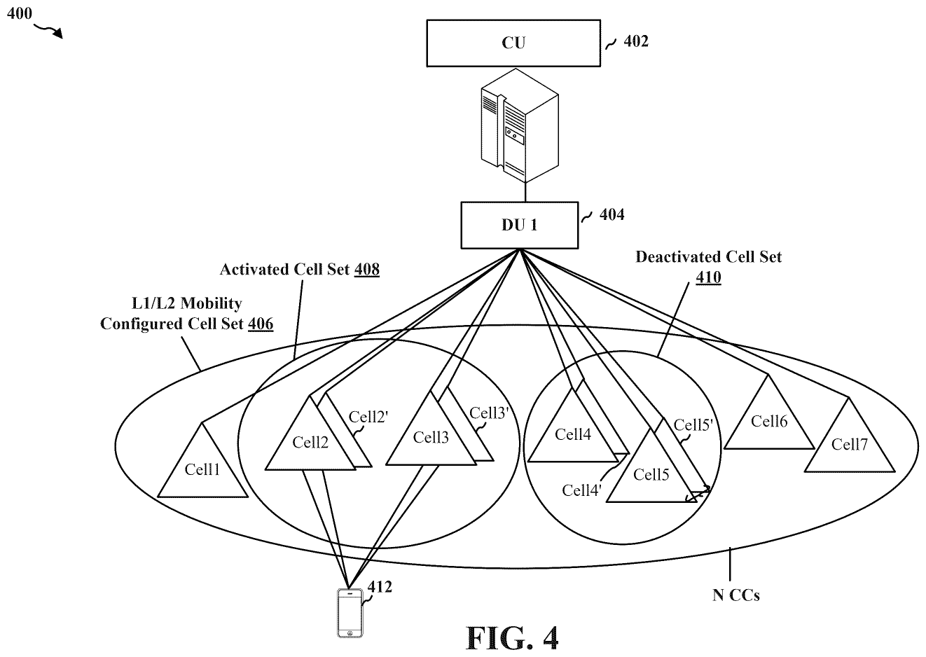

FIG. 4 is a diagram 400 illustrating an example cell configuration. As illustrated in FIG. 4, a CU 402 (which may correspond to a component of a base station such as a gNB) may be associated with a first DU 404 (and other DUs). An L1/L2 mobility configured cell set 406 may be associated with the first DU 404 and may include an L1/L2 mobility activated cell set 408 and an L1/L2 mobility deactivated cell set 410. The L1/L2 mobility configured cell set 406 may also include one or more cells not in the current L1/L2 mobility activated cell set 408 or the current L1/L2 mobility deactivated cell set 410. For example, at a given time, the L1/L2 mobility activated cell set 408 may include a first subset of cells in the L1/L2 mobility configured cell set, and the L1/L2 mobility deactivated cell set 410 may include a second, non-overlapping subset of cells in the L1/L2 mobility configured cell set. There may remain one or more cells that are in the L1/L2 mobility configured cell set that are not in the first set subset (e.g., activated) or the second subset (e.g., deactivated). A UE 412 may use the cells in the L1/L2 mobility activated cell set 408 for the data channel and control channel communications.

A UE may be configured with a set of cells for L1/L2 mobility. The set of the cells for L1/L2 mobility may be RRC configured and may include a single SpCell and multiple SCells at a given time. An SpCell may correspond, e.g., to a PCell or a PScell. The SCells may be updated as a SpCell, e.g., changed to a SpCell configuration or activated as a SpCell, using L1/L2 signaling, and the SpCell may be updated as, e.g., changed to, an SCell using L1/L2 signaling. For example, a cell may switch between acting as a SpCell and an SCell for the UE.

In L1/L2 mobility, at least the SpCell may be updated via L1/L2 signaling based on L1 measurements, and the procedure of L1/L2 based inter-cell mobility may be applicable to both intra-frequency and inter-frequency scenarios.

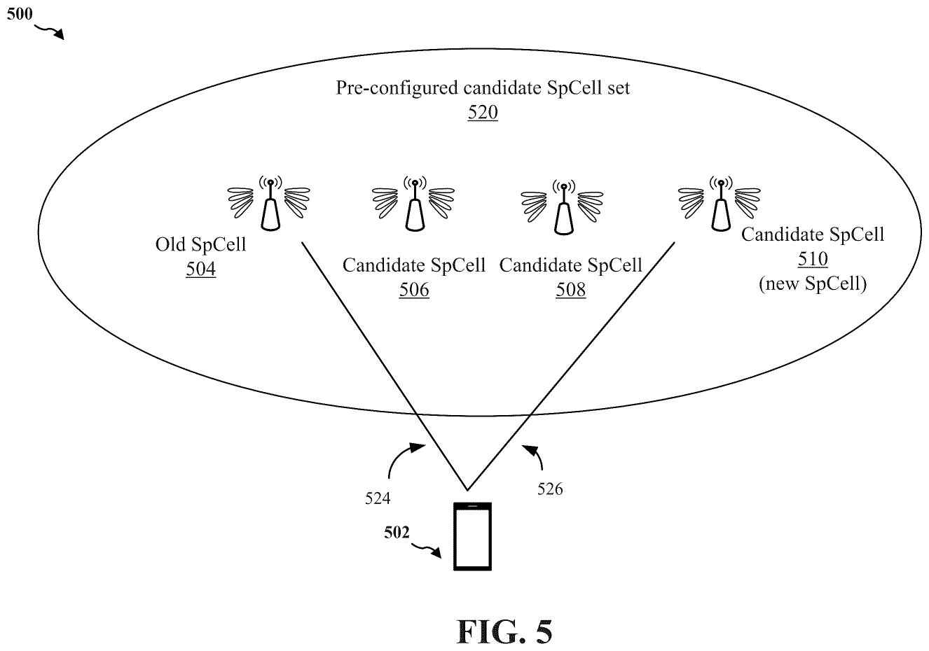

FIG. 5 is a diagram 500 illustrating a system model of the SpCell switch. As shown in FIG. 5, a UE 502 may be configured with a pre-configured candidate SpCell set 520. The candidate SpCell set 520 may include, for example, the old SpCell 504 (e.g., SpCell prior to the change, which may also be referred to as a current SpCell) and one or more candidate SpCells (506, 508, 510) for L1/L2 inter-cell mobility. In one example, the candidate SpCell 510 may be the new SpCell to which the UE 502 will switch. The set of SpCells may be configured as SpCell candidates through RRC signaling. The SpCells in the pre-configured candidate SpCell set 520 may be controlled (e.g., activated and deactivated) by L1/L2 mobility signaling. The L1/L2 mobility signaling may be implemented in a DCI format (for L1) or a MAC-CE format (for L2).

As shown in FIG. 5, the UE 502 may be first connected with a current SpCell 504 (which may be referred to as an old SpCell or a prior SpCell) through a current connection 524 (which may be referred to as an old connection or a prior connection). When the UE 502 moves, the UE 502 may be indicated to switch SpCell from the current SpCell 504 to a new SpCell (e.g., the candidate SpCell 510 through the new connection 526) in the candidate SpCell set 520. The SpCell switch may be implemented through L1/L2 mobility.

The present disclosure provides apparatus of method for the transmit power accumulation for PRACH transmission in candidate cells in L1 and L2 mobility.

A UE may use a random access procedure, e.g., including PRACH transmissions, in order to communicate with a base station or a cell. For example, the UE may use the random access procedure to request an RRC connection, to re-establish an RRC connection, resume an RRC connection, etc. A UE may use a random access procedure in order to communicate with a base station. For example, the UE may use the random access procedure to request an RRC connection, to re-establish an RRC connection, resume an RRC connection, etc. Random Access Procedures may include Contention Based Random Access (CBRA) and Contention Free Random Access (CFRA). For example, the UE may use CBRA when a UE is not synchronized with a base station, and the CFRA may be applied, e.g., when the UE was previously synchronized to a base station. Both procedures include transmission of a random access preamble from the UE to the base station. In CBRA, a UE may randomly select a random access preamble sequence, e.g., from a set of preamble sequences. As the UE randomly selects the preamble sequence, the base station may receive another preamble from a different UE at the same time. Thus, CBRA provides for the base station to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention free” random access.

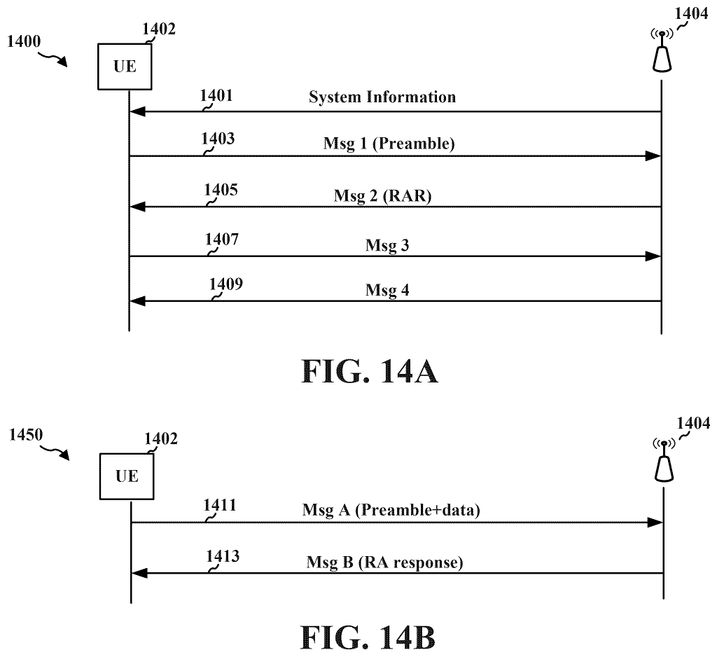

FIG. 14A illustrates example aspects of a random access procedure 1400 between a UE 1402 and a base station 1404. The UE 1402 may initiate the random access message exchange by sending, to the base station 1404, a first random access message 1403 (e.g., Msg 1) including a preamble. Prior to sending the first random access message 1403, the UE may obtain random access parameters, e.g., including preamble format parameters, time and frequency resources, parameters for determining root sequences and/or cyclic shifts for a random access preamble, etc., e.g., in system information 1401 from the base station 1404. The preamble may be transmitted with an identifier, such as a Random Access RNTI (RA-RNTI). The UE 1402 may randomly select a random access preamble sequence, e.g., from a set of preamble sequences. If the UE 1402 randomly selects the preamble sequence, the base station 1404 may receive another preamble from a different UE at the same time. In some examples, a preamble sequence may be assigned to the UE 1402.

The base station responds to the first random access message 1403 by sending a second random access message 1405 (e.g. Msg 2) using PDSCH and including a random access response (RAR). The RAR may include, e.g., an identifier of the random access preamble sent by the UE, a time advance (TA), an uplink grant for the UE to transmit data, cell radio network temporary identifier (C-RNTI) or other identifier, and/or a back-off indicator. Upon receiving the RAR (e.g., 1405), the UE 1402 may transmit a third random access message 1407 (e.g., Msg 3) to the base station 1404, e.g., using PUSCH, that may include an RRC connection request, an RRC connection re-establishment request, or an RRC connection resume request, depending on the trigger for the initiating the random access procedure. The base station 1404 may then complete the random access procedure by sending a fourth random access message 1409 (e.g., Msg 4) to the UE 1402, e.g., using PDCCH for scheduling and PDSCH for the message. The fourth random access message 1409 may include a random access response message that includes timing advancement information, contention resolution information, and/or RRC connection setup information. The UE 1402 may monitor for PDCCH, e.g., with the C-RNTI. If the PDCCH is successfully decoded, the UE 1402 may also decode PDSCH. The UE 1402 may send HARQ feedback for any data carried in the fourth random access message. If two UEs sent the same preamble at 1403, both UEs may receive the RAR leading both UEs to send a third random access message 1407. The base station 1404 may resolve such a collision by being able to decode the third random access message from only one of the UEs and responding with a fourth random access message to that UE. The other UE, which did not receive the fourth random access message 1409, may determine that random access did not succeed and may re-attempt random access. Thus, the fourth message may be referred to as a contention resolution message. The fourth random access message 1409 may complete the random access procedure. Thus, the UE 1402 may then transmit uplink communication and/or receive downlink communication with the base station 1404 based on the message 1409.

In order to reduce latency or control signaling overhead, a single round trip cycle between the UE and the base station may be achieved in a 2-step RACH process 1450, such as shown in FIG. 14B. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same random access occasions (ROs) as the preambles of the four step RACH procedure or may be transmitted in separate ROs. The PUSCH transmissions may be transmitted in PUSCH occasions (POs) that may span multiple symbols and PRBs. After the UE 1402 transmits the Msg A 1411, the UE 1402 may wait for a response from the base station 1404. Additionally, aspects of the Msg 2 and Msg 4 may be combined into a single message, which may be referred to as Msg B. Two step RACH may be triggered for reasons similar to a four-step RACH procedure. If the UE does not receive a response, the UE may retransmit the MsgA or may fall back to a four-step RACH procedure starting with a Msg 1. If the base station detects the Msg A, but fails to successfully decode the Msg A PUSCH, the base station may respond with an allocation of resources for an uplink retransmission of the PUSCH. The UE may fallback to the four step RACH with a transmission of Msg 3 based on the response from the base station and may retransmit the PUSCH from Msg A. If the base station successfully decodes the Msg A and corresponding PUSCH, the base station may reply with an indication of the successful receipt, e.g., as a random access response 1413 that completes the two-step RACH procedure. The Msg B may include the random access response and a contention-resolution message. The contention resolution message may be sent after the base station successfully decodes the PUSCH transmission.

For L1/L2-based inter-cell mobility, a PRACH transmission may be used for a base station to evaluate transmission parameters, such as the timing advance (TA) for the uplink transmission, the beam (including the receiving and transmit beams), and the transmit power for the uplink transmission. The transmission parameters may be evaluated through the retransmission of the PRACH. For example, when a first PRACH transmission fails (e.g., when the UE does not receive a proper response from the base station for the first PRACH transmission), the UE may ramp up (i.e., increase) the transmit power and retransmit the PRACH until the PRACH is received correctly by the base station.

However, for L1/L2-based inter-cell mobility, the PRACH retransmission may cause significant latency. For example, for a UE to perform a PRACH retransmission, the UE may have to wait until the response window or timer for receiving the response of the first PRACH transmission has expired, which may result in significant latency. The present disclosures support the base station to indicate, through DCI, transmission parameters for PRACH transmission to lower the latency.

In one aspect of the present disclosure, in L1/L2 mobility, the base station may transmit a trigger signal to trigger the UE to transmit PRACH for the candidate cells. The trigger signal may be transmitted through, for example, an active serving cell, to the UE. For example, as shown in FIG. 5, the active serving cell may be the old SpCell 504, and the candidate cells may be one or more of the candidate SpCells 506, 508, and 510. The trigger signal may include PRACH parameters, which may include, but are not limited to, the random-access preamble index, the SS/PBCH index, the PRACH mask index, and the candidate cell index information.

Additionally, the trigger signal may further include PRACH parameters dedicated to L1/L2 mobility. For example, the trigger signal may include a transmit power indication (e.g., transmit power command (TPC)), which may allow transmit power adjustment such as power ramping for the base station-triggered PRACH transmissions. For another example, the trigger signal may include a target transmit power indication (e.g., an indication for the PRACH target reception power), which may select one of predetermined target reception powers for the base station-triggered PRACH transmissions.

Upon receiving the trigger signal, in one configuration, the UE may apply a single closed loop index for power ramping for the PRACH transmission, and the accumulation of transmit power for the PRACH transmission may be reflected by the closed loop index. The initial value of the closed loop index may be default to 0. For example, the UE may receive multiple trigger signals for the PRACH transmission, and each of the trigger signals may include a TPC indicating a transmit power for the PRACH transmission. The accumulation of the indicated TPCs may be reflected by a single closed loop index.

In another configuration, the UE may have multiple closed loop indices for the power ramping, and the UE may apply one closed loop index of the multiple closed loop indices for the transmit power of the PRACH transmission. The selection of the one closed loop index may be indicated through an RRC configuration. In one example, the UE may receive multiple trigger signals for the PRACH transmission, and each of the trigger signals may include a TPC indicating a transmit power for the PRACH transmission. The multiple trigger signals may correspond to multiple closed loop indices. The accumulation of the indicated TPCs may be associated with, based on the RRC configuration, one closed loop index of the multiple closed loop indices.

When the UE is triggered to transmit PRACH for a candidate cell, in one configuration, the UE may rely on the transmit power indicated by one trigger signal for the PRACH transmission and does not apply any power ramping for the transmit power. For example, when the UE is triggered to transmit PRACH, the transmit power of the PRACH transmission may be based on the TPC of one trigger signal and there is no transmit power accumulation across multiple trigger signals that the UE may have received.

In another configuration, the UE may accumulate the transmit powers indicated for the PRACH transmission. For example, the UE may receive multiple trigger signals for the PRACH transmission, and each of the trigger signals may include a TPC indicating a transmit power for the PRACH transmission. The UE may accumulate the TPCs from the multiple trigger signals for the PRACH transmission. A field may indicate the start or the end (or both) for the TPC accumulation. In one example, the field may be a new date information (NDI) field. If the NDI field is toggled (i.e., the NDI field has a first value), the TPC accumulation may be reset, indicating a start point of a new TPC accumulation. Otherwise, if the NDI field is not toggled (i.e., the NDI field has a second value), the current TPC accumulation may be continued.

The TPC of the trigger signal may be associated with a step size. In one configuration, the step size may be a fixed step size. For example, the TPC may indicate an adjustment to the transmit power (e.g., an increase of 1 dB or a decrease of 1 dB), and the step size of the adjustment may be a fixed step size (e.g., 1 dB). In another configuration, the step size of the adjustment may be configurable by RRC signaling, or dynamically indicated through signaling via, for example, a medium access control-control element (MAC-CE) or DCI. For example, the TPC of one trigger signal may indicate the UE to increase 5 dB for the transmit power of the PRACH transmission, and the UE may receive an indication via the MAC-CE or DCI to increase the step size to 5 dB to adapt to the PRACH transmission.

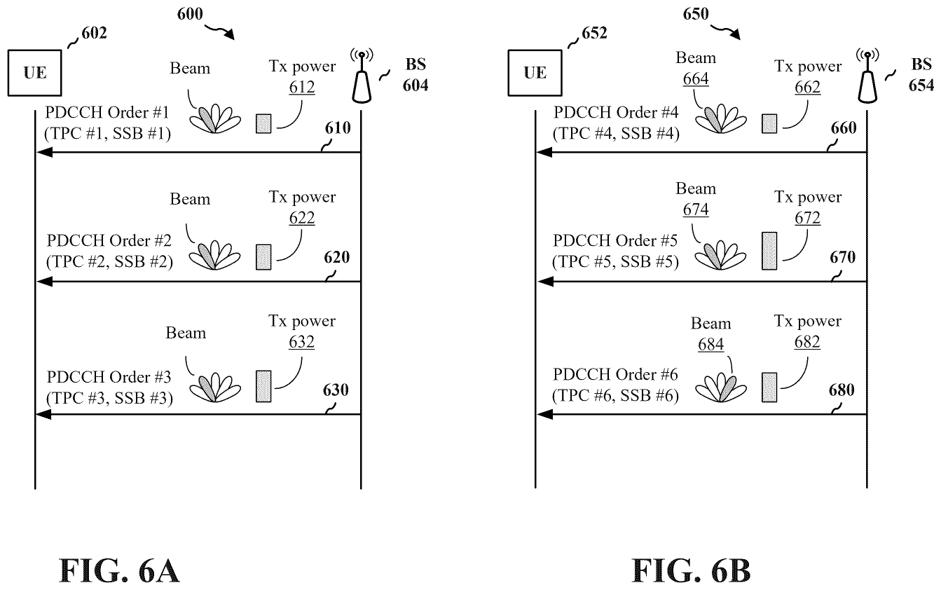

FIG. 6A is a diagram 600 illustrating an example of power ramping for PRACH transmission. As shown in FIG. 6A, the UE 602 may receive multiple trigger signals, such as the PDCCH orders received at 610, 620, and 630, from the base station 604. Each of the trigger signals may include a TPC (e.g., TPC #1, TPC #2, TPC #3), and the TPCs may indicate different transmit powers for the PRACH transmission (e.g., Tx powers 612, 622, and 632). The UE 602 may accumulate the TPCs from the multiple trigger signals for the PRACH transmission. The start and/or the end of the TPC accumulation may be indicated by the base station through a field (e.g., the NDI field) in the DCI. For example, through a field in the DCI, the UE 602 may be indicated to accumulate the TPCs from the second trigger signal (i.e., TPC #2) to the third trigger signal (i.e., TPC #3), or to accumulate the TPCs from the first trigger signal (i.e., TPC #1) to the third trigger signal (i.e., TPC #3).

In L1/L2 mobility, when the UE receives multiple trigger signals for the PRACH transmission, the trigger signals may indicate the UE to use different beams for the PRACH transmission. For example, the trigger signals may indicate different SSBs for the PRACH transmissions. In one configuration, the UE does not accumulate the transmit power when a trigger signal indicates a different beam for the PRACH transmission (i.e, the TPC accumulation is reset when the beam is changed). In another configuration, the UE may continue the TPC accumulation when a trigger signal indicates a different beam for the PRACH transmission (i.e., the TPC accumulation is performed on different beams).

FIG. 6B is a diagram 650 illustrating an example of power ramping for PRACH transmission. As shown in FIG. 6B, the UE 652 may receive multiple trigger signals from the base station 654, such as the PDCCH orders received at 660, 670, and 680. Each of the trigger signals may include a TPC (e.g., TPC #4, TPC #4, TPC #6), and the TPCs may indicate different transmit powers for the PRACH transmission (e.g., Tx powers 662, 672, and 682). The UE 652 may accumulate the TPCs from the multiple trigger signals for the PRACH transmission. The trigger signal may indicate the beam for the PRACH transmission, via, for example, the SSB. In one example, the UE 652 may not accumulate the transmit power when a trigger signal indicates a different beam for the PRACH transmission. For example, when the PDCCH Order #6 (received at 680) indicates a beam 684 that is different from the beam 674 indicated by PDCCH Order #5 (received at 670), the UE 652 may reset the TPC accumulation. In another example, the UE 652 may continue the TPC accumulation even if there is a beam change. That is, the UE 652 may perform the TPC accumulation on TPC #4, TPC #5, and TPC #6, even the PDCCH Order #6 indicates a beam 684 that is different from the beams in previous PDCCH Orders (e.g., beam 664 and beam 674).

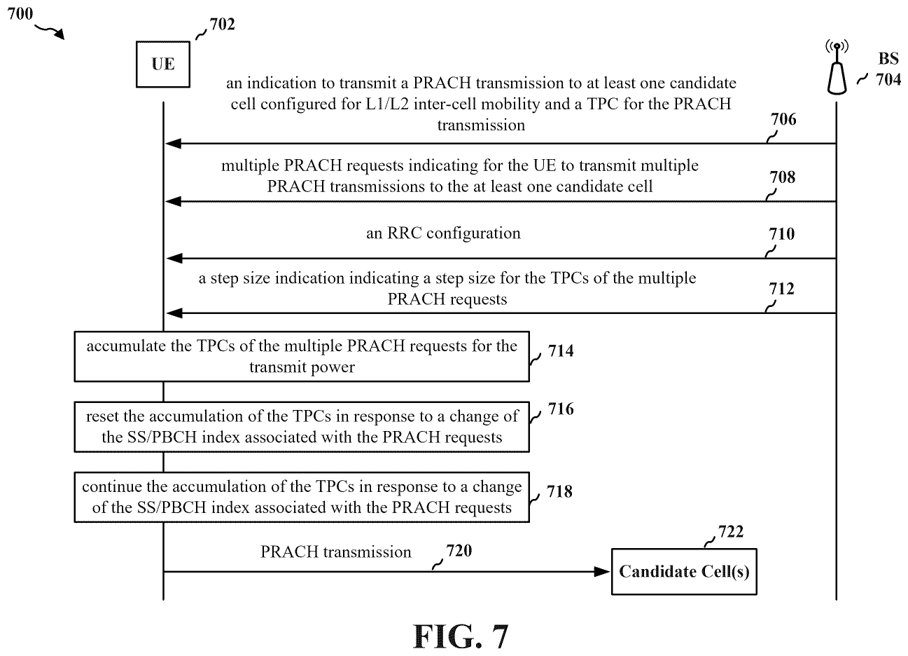

FIG. 7 is a call flow diagram 700 illustrating a method of wireless communication in accordance with various aspects of this present disclosure. Although aspects are described for a base station 704, the aspects may be performed by a base station in aggregation and/or by one or more components of a base station 704 (e.g., such as a CU 110, a DU 130, and/or an RU 140).

As shown in FIG. 7, at 706, the base station 704 may transmit, to the UE 702, an indication to transmit a PRACH transmission to at least one candidate cell configured for L1/L2 inter-cell mobility and a TPC for the PRACH transmission. The base station 704 may transmit the indication through a serving cell. The serving cell may be a SpCell that is connected to the UE 702, such as the SpCell 504 of FIG. 5. The at least one candidate cell may be the cell that may be connected to the UE 702 through L1/L2 mobility. For example, the candidate cell may be one of the candidate SpCells 506, 508, and 510 in FIG. 5.

At 708, the base station 704 may transmit multiple PRACH requests to the UE 702. The multiple PRACH requests may indicate for the UE to transmit multiple PRACH transmissions to the at least one candidate cell. For example, the multiple PRACH requests may be multiple PDCCH orders (e.g., PDCCH orders #1-#3) in FIG. 6A or multiple PDCCH orders (e.g., PDCCH orders #4-#6) in FIG. 6B.

At 710, the base station 704 may transmit an RRC configuration to the UE 702. The RRC configuration may indicate the UE 702 to select one closed loop index from multiple closed loop indices for the TPC accumulation for the transmit power.

At 712, the base station 704 may transmit a step size indication to the UE 702. The step size indication may indicate a step size for the TPCs of the multiple PRACH requests.

At 714, the UE 702 may accumulate the TPCs of the multiple PRACH requests for the transmit power. For example, as shown in FIG. 6A, the UE 602 may accumulate the TPCs (e.g., TPC #1, TPC #2, TPC #3) of the multiple PRACH requests (e.g., PDCCH Orders #1-#3). As shown in FIG. 6B, the UE 652 may accumulate the TPCs (e.g., TPC #4, TPC #5, TPC #6) of the multiple PRACH requests (e.g., PDCCH Orders #4-#6).

At 716, the UE 702 may reset the TPC accumulation in response to a change of the SS/PBCH index associated with the PRACH requests. For example, as shown in FIG. 6B, one PRACH request (i.e., PDCCH Order #6) may indicate, through the SS/PBCH index, a change of beam from beam 674 in PDCCH Order #5 to beam 684. In response to the change of the beam, the UE 652 may reset the TPC accumulation. That is, the UE 652 may perform the TPC accumulation on the same beam.

At 718, the UE 702 may continue the TPC accumulation in response to a change of the SS/PBCH index associated with the PRACH requests. For example, as shown in FIG. 6B, one PRACH request (i.e., PDCCH Order #6) may indicate, through the SS/PBCH index, a change of beam from beam 674 in PDCCH Order #5 to beam 684. The UE 652 may continue the TPC accumulation when the indicated beam is changed. That is, the UE 652 may perform the TPC accumulation on different beams.

At 720, the UE 702 may transmit the PRACH transmission to the at least one candidate cell 722 using a transmit power based on the TPC. The transmit power may be the accumulated transmit power based on the TPC accumulation performed on multiple PRACH requests.

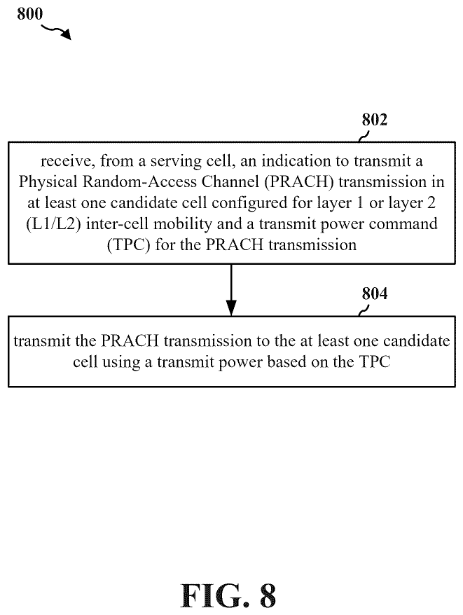

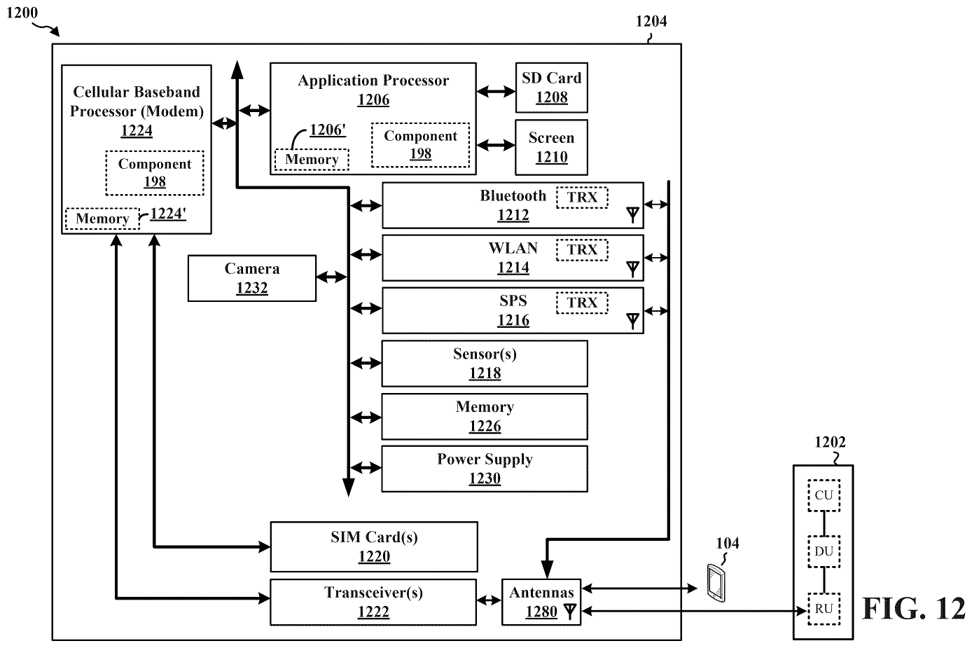

FIG. 8 is a flowchart 800 illustrating methods of wireless communication at a UE in accordance with various aspects of the present disclosure. The methods may be performed by a UE. The UE may be the UE 104, 350, 602, 652, 702, or the apparatus 1204 in the hardware implementation of FIG. 12. The methods enable the indication of PRACH transmission parameters and the power ramping for the transmit power through, for example, DCI. They reduce the latency of the PRACH transmission and improve the efficiency of wireless communication.

As shown in FIG. 8, at 802, the UE may receive, from a serving cell, an indication to transmit a PRACH transmission to at least one candidate cell configured for L1/L2 inter-cell mobility and a TPC for the PRACH transmission. The serving cell may be a base station, or a component of a base station, in the access network of FIG. 1 or a core network component (e.g., base station 102, 310, 604, 654, 704; or the network entity 1202 in the hardware implementation of FIG. 12). FIGS. 5, 6A, 6B, and 7 illustrate various aspects of the steps in connection with flowchart 800. For example, referring to FIG. 7, the UE 702 may receive, at 706, from a serving cell (base station 704), an indication to transmit a PRACH transmission to at least one candidate cell configured for L1/L2 inter-cell mobility and a TPC for the PRACH transmission. Referring to FIG. 5, in one example, the serving cell may be the old SpCell 504, and the at least one candidate cell may be one or more of the candidate SpCells 506, 508, and 510.

At 804, the UE may transmit the PRACH transmission to the at least one candidate cell using a transmit power based on the TPC. For example, referring to FIG. 7, the UE 702 may transmit, at 720, the PRACH transmission to the at least one candidate cell 722 using a transmit power based on the TPC.

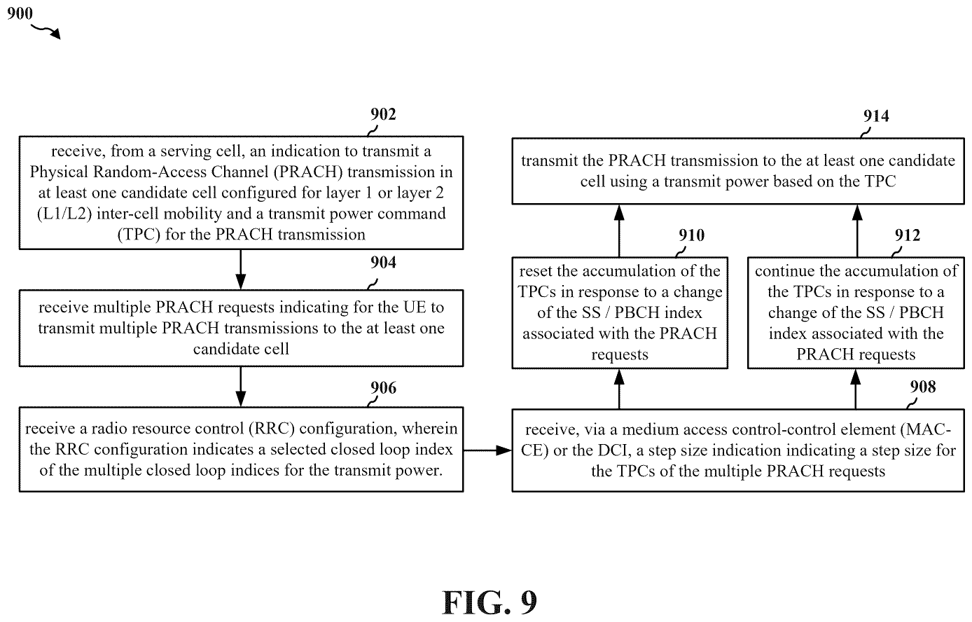

FIG. 9 is a flowchart 900 illustrating methods of wireless communication at a UE in accordance with various aspects of the present disclosure. The methods may be performed by a UE. The UE may be the UE 104, 350, 602, 652, 702, or the apparatus 1204 in the hardware implementation of FIG. 12. The methods enable the indication of PRACH transmission parameters and the power ramping for the transmit power through, for example, DCI. They reduce the latency of the PRACH transmission and improve the efficiency of wireless communication.

As shown in FIG. 9, at 902, the UE may receive, from a serving cell, an indication to transmit a PRACH transmission to at least one candidate cell configured for L1/L2 inter-cell mobility and a TPC for the PRACH transmission. The serving cell may be a base station, or a component of a base station, in the access network of FIG. 1 or a core network component (e.g., base station 102, 310, 604, 654, 704; or the network entity 1202 in the hardware implementation of FIG. 12). FIGS. 5, 6A, 6B, and 7 illustrate various aspects of the steps in connection with flowchart 900. For example, referring to FIG. 7, the UE 702 may receive, at 706, from a serving cell (base station 704), an indication to transmit a PRACH transmission to at least one candidate cell configured for L1/L2 inter-cell mobility and a TPC for the PRACH transmission. Referring to FIG. 5, in one example, the serving cell may be the old SpCell 504, and the at least one candidate cell may be one or more of the candidate SpCells 506, 508, and 510.

At 904, the UE may receive multiple PRACH requests indicating for the UE to transmit multiple PRACH transmissions to the at least one candidate cell. Each of the multiple PRACH requests may include a corresponding TPC and PRACH parameters. The PRACH parameters may include one or more of: a Random-Access Preamble index, a SS/PBCH index, a PRACH mask index, and the candidate cell index information. For example, referring to FIG. 7, the UE 702 may receive, at 708, multiple PRACH requests indicating for the UE 702 to transmit multiple PRACH transmissions to the at least one candidate cell. Referring to FIGS. 6A and 6B, each of the multiple PRACH requests (PDCCH Orders #1-#6) may include a corresponding TPC (TPCs #1-#6) and PRACH parameters. The PRACH parameters may include one or more of: a Random-Access Preamble index, a SS/PBCH index, a PRACH mask index, and the candidate cell index information.

In some aspects, the multiple PRACH requests may be included in DCI. In one configuration, the transmit power may be based on the TPC of one PRACH request of the multiple PRACH requests. In another configuration, the transmit power may be based on the accumulation of the TPCs of the multiple PRACH requests. For example, referring to FIG. 7, the multiple PRACH requests (which the UE 702 receives at 708) may be included in DCI. When the UE 702 performs, at 720, the PRACH transmission, in one configuration, the transmit power of the PRACH transmission may be based on the TPC of one PRACH request of the multiple PRACH requests (which the UE 702 receives at 708); in another configuration, the transmit power of the PRACH transmission may be based on the accumulation of the TPCs of the multiple PRACH requests (which the UE 702 receives at 708).

In some aspects, the accumulation of the TPCs may be associated with a single closed loop index in combination for the multiple PRACH transmissions. For example, referring to FIGS. 6A and 6B, the accumulation of the TPCs (e.g., the accumulation of TPCs #1-#3 or the accumulation TPCs #4-#6) may be associated with a single closed loop index in combination for the multiple PRACH transmissions.

In some aspects, the accumulation of the TPCs may be associated with multiple closed loop indices with a separate closed loop index for each of the multiple PRACH transmissions. For example, referring to FIGS. 6A and 6B, the accumulation of the TPCs (e.g., the accumulation of TPCs #1-#3 or the accumulation TPCs #4-#6) may be associated with multiple closed loop indices. A separate closed loop index of the multiple closed loop indices may correspond to each of the multiple PRACH transmissions.

At 906, the UE may receive an RRC configuration. The RRC configuration may indicate a selected closed loop index of the multiple closed loop indices for the transmit power. For example, referring to FIG. 7, the UE 702 may receive, at 710, an RRC configuration. The RRC configuration may indicate a selected closed loop index of the multiple closed loop indices for the transmit power.

In some aspects, the DCI indicates at least one of a start or an end for the accumulation of the TPCs of the multiple PRACH requests. For example, referring to FIG. 6A, in one example, the DCI may indicate the TPC accumulation be performed on TPC #2 and TPC #3 (i.e., the DCI indicates the TPC accumulation starts on PDCCH Order #2, and ends on PDCCH Order #3). In another example, the DCI may indicate the TPC accumulation be performed on TPC #1, TPC #2, and TPC #3 (i.e., the DCI indicates the TPC accumulation starts on PDCCH Order #1, and ends on PDCCH Order #3).

In some aspects, an NDI field in the DCI may indicate the at least one of the start or the end for the accumulation of the TPCs. A first value of the NDI field may indicate a reset of the accumulation, and a second value of the NDI field does not indicate the reset. For example, referring to FIG. 6A, when the DCI indicates at least one of the start or the end of the TPC accumulation, the DCI may indicate the start and/or the end through an NDI field in the DCI. For example, if the NDI field associated with PDCCH Order #2 is the first value, the TPC accumulation may be reset, indicating the start of the TPC accumulation at PDCCH Order #2. On the other hand, if the NDI field associated with PDCCH Order #2 has a second value that is different from the first value, the TPC accumulation may not be reset.

In some aspects, the TPCs of the multiple PRACH requests may be based on a fixed step size. For example, referring to FIGS. 6A and 6B, the TPCs of the multiple PRACH requests (TPCs #1-#3 and TPCs #4-#6) may be based on a fixed step size. That is, the difference between TPCs #1-#3 may be based on one or more fixed step sizes, and the difference between TPCs #4-#6 may be based on one or more fixed step sizes.

At 908, the UE may receive, via a MAC-CE or the DCI, a step size indication indicating a step size for the TPCs of the multiple PRACH requests. For example, referring to FIG. 7, the UE 702 may receive, at 712, via a MAC-CE or the DCI, a step size indication indicating a step size for the TPCs of the multiple PRACH requests.

At 910, the UE may reset the accumulation of the TPCs in response to a change of the SS/PBCH index associated with the PRACH requests. For example, referring to FIG. 7, the UE 702 may reset, at 716, the accumulation of the TPCs in response to a change of the SS/PBCH index associated with the PRACH requests. Referring to FIG. 6B, the UE 652 may reset the accumulation of the TPCs in response to a change of the SS/PBCH index associated with the PRACH requests (a change of beam from Beam 674 in PDCCH Order #5 to Beam 684 in PDCCH Order #6).

At 912, the UE may continue the accumulation of the TPCs in response to a change of the SS/PBCH index associated with the PRACH requests. For example, referring to FIG. 7, the UE 702 may, at 718, continue the accumulation of the TPCs in response to a change of the SS/PBCH index associated with the PRACH requests. Referring to FIG. 6B, the UE 652 may continue the accumulation of the TPCs in response to a change of the SS/PBCH index associated with the PRACH requests (a change of beam from Beam 674 in PDCCH Order #5 to Beam 684 in PDCCH Order #6).

At 914, the UE may transmit the PRACH transmission to the at least one candidate cell using a transmit power based on the TPC. For example, referring to FIG. 7, the UE 702 may transmit, at 720, the PRACH transmission to the at least one candidate cell 722 using a transmit power based on the TPC. Referring to FIG. 5, the at least one candidate cell may be one or more of the candidate SpCells 506, 508, and 510.

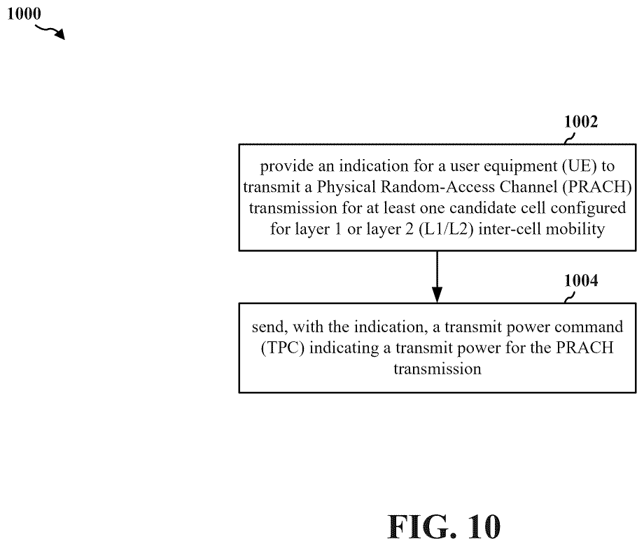

FIG. 10 is a flowchart 1000 illustrating methods of wireless communication at a network entity in accordance with various aspects of the present disclosure. The methods may be performed by a network entity. The network entity may be a base station, or a component of a base station, in the access network of FIG. 1 or a core network component (e.g., base station 102, 310, 604, 654, 704; or the network entity 1202 in the hardware implementation of FIG. 12). The methods enable the indication of PRACH transmission parameters and the power ramping for the transmit power through, for example, DCI. They reduce the latency of the PRACH transmission and improve the efficiency of wireless communication.

As shown in FIG. 10, at 1002, the network entity may provide an indication for a UE to transmit a PRACH transmission for at least one candidate cell configured for L1/L2 inter-cell mobility. The UE may be the UE 104, 350, 602, 652, 702, or the apparatus 1204 in the hardware implementation of FIG. 12. FIGS. 5, 6A, 6B, and 7 illustrate various aspects of the steps in connection with flowchart 1000. For example, referring to FIG. 7, the network entity (base station 704) may provide, at 706, an indication for a UE 702 to transmit a PRACH transmission for at least one candidate cell configured for L1/L2 inter-cell mobility. Referring to FIG. 5, the at least one candidate cell may be one or more of the candidate SpCells 506, 508, and 510.

At 1004, the network entity may send, with the indication, a TPC indicating a transmit power for the PRACH transmission. For example, referring to FIG. 7, the network entity (base station 704) may send, at 706, with the indication, a TPC indicating a transmit power for the PRACH transmission.

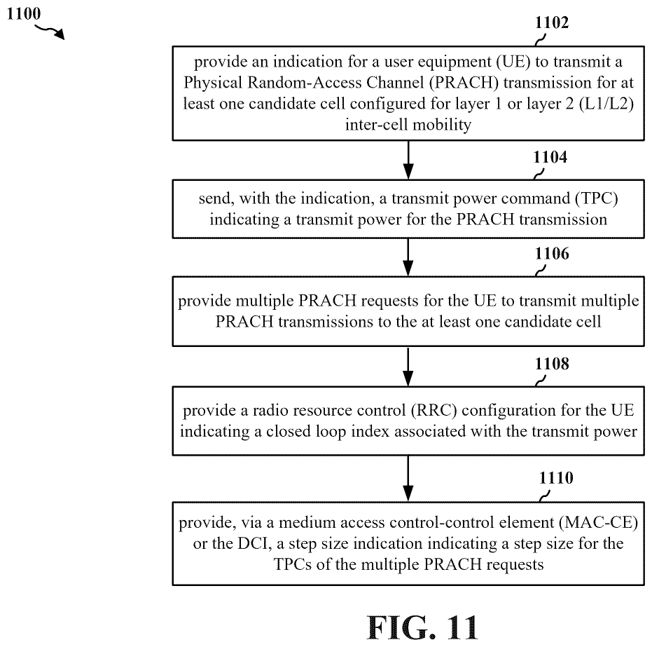

FIG. 11 is a flowchart 1100 illustrating methods of wireless communication at a network entity in accordance with various aspects of the present disclosure. The methods may be performed by a network entity. The network entity may be a base station, or a component of a base station, in the access network of FIG. 1 or a core network component (e.g., base station 102, 310, 604, 654, 704; or the network entity 1202 in the hardware implementation of FIG. 12). The methods enable the indication of PRACH transmission parameters and the power ramping for the transmit power through, for example, DCI. They reduce the latency of the PRACH transmission and improve the efficiency of wireless communication.

As shown in FIG. 11, at 1102, the network entity may provide an indication for a UE to transmit a PRACH transmission for at least one candidate cell configured for L1/L2 inter-cell mobility. The UE may be the UE 104, 350, 602, 652, 702, or the apparatus 1204 in the hardware implementation of FIG. 12. FIGS. 5, 6A, 6B, and 7 illustrate various aspects of the steps in connection with flowchart 1100. For example, referring to FIG. 7, the network entity (base station 704) may provide, at 706, an indication for a UE 702 to transmit a PRACH transmission for at least one candidate cell configured for L1/L2 inter-cell mobility. Referring to FIG. 5, the at least one candidate cell may be one or more of the candidate SpCells 506, 508, and 510.

At 1104, the network entity may send, with the indication, a TPC indicating a transmit power for the PRACH transmission. For example, referring to FIG. 7, the network entity (base station 704) may send, at 706, with the indication, a TPC indicating a transmit power for the PRACH transmission.

At 1106, the network entity may provide multiple PRACH requests for the UE to transmit multiple PRACH transmissions to the at least one candidate cell. Each of the multiple PRACH requests may include a corresponding TPC and PRACH parameters. The PRACH parameters may include one or more of: a Random-Access Preamble index, a SS/PBCH index, a PRACH mask index, and the candidate cell index information. For example, referring to FIG. 7, the network entity (base station 704) may provide, at 708, multiple PRACH requests indicating for the UE 702 to transmit multiple PRACH transmissions to the at least one candidate cell. Referring to FIGS. 6A and 6B, each of the multiple PRACH requests (PDCCH Orders #1-#6) may include a corresponding TPC (TPCs #1-#6) and PRACH parameters. The PRACH parameters may include one or more of: a Random-Access Preamble index, a SS/PBCH index, a PRACH mask index, and the candidate cell index information.

In some aspects, the multiple PRACH requests may be included in DCI. For example, referring to FIG. 7, the multiple PRACH requests (which the base station 704 transmits at 708) may be included in DCI.

In some aspects, the transmit power may be based on an accumulation of the TPCs of the multiple PRACH requests. For example, referring to FIG. 7, when the UE 702 performs, at 720, the PRACH transmission, the transmit power of the PRACH transmission may be based on the accumulation of the TPCs of the multiple PRACH requests (which the base station 704 transmits at 708).

At 1108, the network entity may provide an RRC configuration for the UE, indicating a closed loop index associated with the transmit power. For example, referring to FIG. 7, the network entity (base station 704) may provide, at 710, an RRC configuration. The RRC configuration may indicate a closed loop index associated with the transmit power.

In some aspects, the DCI may indicate at least one of a start or an end for the accumulation of the TPCs. For example, referring to FIG. 6A, in one example, the DCI may indicate the TPC accumulation be performed on TPC #2 and TPC #3 (i.e., the DCI indicates the TPC accumulation starts on PDCCH Order #2, and ends on PDCCH Order #3). In another example, the DCI may indicate the TPC accumulation be performed on TPC #1, TPC #2, and TPC #3 (i.e., the DCI indicates the TPC accumulation starts on PDCCH Order #1, and ends on PDCCH Order #3).

In some aspects, an NDI field in the DCI may indicate the at least one of the start or the end for the accumulation. A first value of the NDI field may indicate the reset of the accumulation of the TPCs, and a second value of the NDI field does not indicate the reset of the accumulation of the TPCs. For example, referring to FIG. 6A, when the DCI indicates at least one of the start or the end of the TPC accumulation, the DCI may indicate the start and/or the end through an NDI field in the DCI. For example, if the NDI field associated with PDCCH Order #2 is the first value, the TPC accumulation may be reset, indicating the start of the TPC accumulation at PDCCH Order #2. On the other hand, if the NDI field associated with PDCCH Order #2 has a second value that is different from the first value, the TPC accumulation may not be reset.

In some aspects, the TPCs of the multiple PRACH requests may be based on a fixed step size. For example, referring to FIGS. 6A and 6B, the TPCs of the multiple PRACH requests (TPCs #1-#3 and TPCs #4-#6) may be based on a fixed step size. That is, the difference between TPCs #1-#3 may be based on one or more fixed step sizes, and the difference between TPCs #4-#6 may be based on one or more fixed step sizes.

At 1110, the network entity may provide, via a MAC-CE or the DCI, a step size indication indicating a step size for the TPCs of the multiple PRACH requests. For example, referring to FIG. 7, the network entity (base station 704) may transmit, at 712, via a MAC-CE or the DCI, a step size indication indicating a step size for the TPCs of the multiple PRACH requests.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see UE 350 of FIG. 3) and include the additional modules of the apparatus 1204.

As discussed supra, the component 198 may be configured to receive, from a serving cell, an indication to transmit a PRACH transmission to at least one candidate cell configured for L1/L2 inter-cell mobility and a TPC for the PRACH transmission; and transmit the PRACH transmission to the at least one candidate cell using a transmit power based on the TPC. The component 198 may be further configured to perform any of the aspects described in connection with the flowcharts in FIG. 8 and FIG. 9, and/or performed by the UE 702 in FIG. 7. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for receiving, from a serving cell, an indication to transmit a PRACH transmission to at least one candidate cell configured for L1/L2 inter-cell mobility and a TPC for the PRACH transmission, and means for transmitting the PRACH transmission to the at least one candidate cell using a transmit power based on the TPC. The apparatus 1204 may further include means for performing any of the aspects described in connection with the flowcharts in FIG. 8 and FIG. 9, and/or aspects performed by the UE 702 in FIG. 7. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

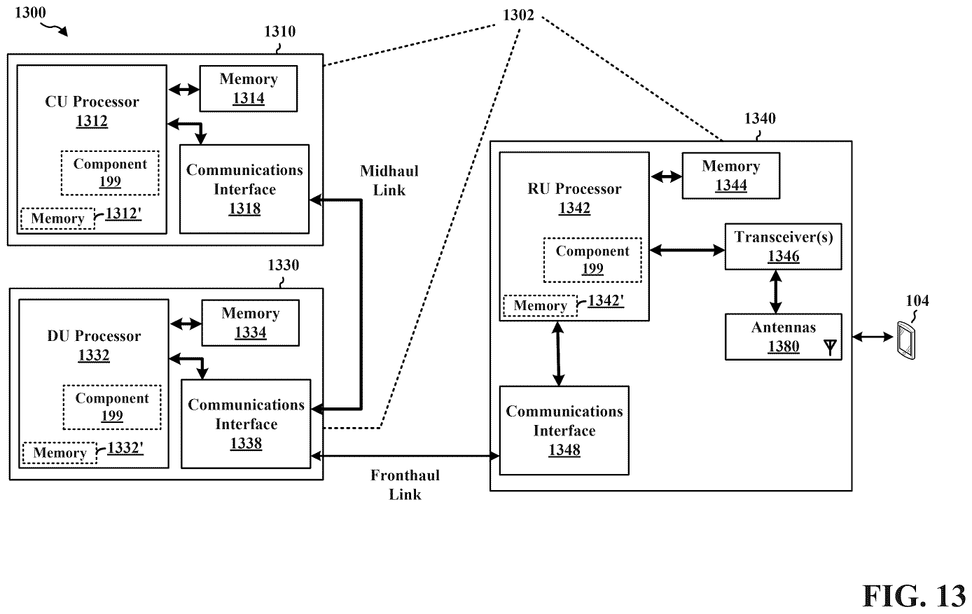

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide an indication for a UE to transmit a PRACH transmission for at least one candidate cell configured for L1/L2 inter-cell mobility; and send, with the indication, a TPC indicating a transmit power for the PRACH transmission. The component 199 may be further configured to perform any of the aspects described in connection with the flowcharts in FIG. 10 and FIG. 11, and/or performed by the base station 704 in FIG. 7. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for providing an indication for a UE to transmit a PRACH transmission for at least one candidate cell configured for L1/L2 inter-cell mobility, and means for sending, with the indication, a TPC indicating a transmit power for the PRACH transmission. The network entity 1302 may further include means for performing any of the aspects described in connection with the flowcharts in FIG. 10 and FIG. 11, and/or aspects performed by the base station 704 in FIG. 7. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a serving cell, an indication to transmit a PRACH transmission to at least one candidate cell configured for L1/L2 inter-cell mobility and a TPC for the PRACH transmission; and transmitting the PRACH transmission to the at least one candidate cell using a transmit power based on the TPC. The method enables the indication of PRACH transmission parameters and the power ramping for the transmit power through, for example, DCI. It reduces the latency of the PRACH transmission and improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include receiving, from a serving cell, an indication to transmit a PRACH transmission to at least one candidate cell configured for L1/L2 inter-cell mobility and a TPC for the PRACH transmission; and transmitting the PRACH transmission to the at least one candidate cell using a transmit power based on the TPC.

Aspect 2 is the method of aspect 1, where the method may further include: receiving multiple PRACH requests indicating for the UE to transmit multiple PRACH transmissions to the at least one candidate cell. Each of the multiple PRACH requests may include a corresponding TPC and PRACH parameters. The PRACH parameters may include one or more of: a Random-Access Preamble index; a SS/PBCH index; and a PRACH mask index.

Aspect 3 is the method of any of aspects 1 to 2, where the multiple PRACH requests may be included in DCI, and the transmit power may be based on the TPC of one PRACH request of the multiple PRACH requests.

Aspect 4 is the method of any of aspects 1 to 2, where the multiple PRACH requests may be included in DCI, and the transmit power may be based on the accumulation of the TPCs of the multiple PRACH requests.

Aspect 5 is the method of aspect 4, where the accumulation of the TPCs may be associated with a single closed loop index in combination for the multiple PRACH transmissions.

Aspect 6 is the method of aspect 4, where the accumulation of the TPCs may be associated with multiple closed loop indices with a separate closed loop index for each of the multiple PRACH transmissions.

Aspect 7 is the method of aspect 6, where the method may further include receiving an RRC configuration. The RRC configuration may indicate a selected closed loop index of the multiple closed loop indices for the transmit power.

Aspect 8 is the method of any of aspects 4 to 7, where the DCI may indicate at least one of the start or the end for the accumulation of the TPCs of the multiple PRACH requests.

Aspect 9 is the method of aspect 8, where an NDI field in the DCI may indicate the at least one of the start or the end for the accumulation of the TPCs. The first value of the NDI field may indicate the reset of the accumulation and the second value of the NDI field does not indicate the reset.

Aspect 10 is the method of any of aspects 4 to 9, where the TPCs of the multiple PRACH requests may be based on a fixed step size.

Aspect 11 is the method of any of aspects 4 to 9, where the method may further include receiving, via a MAC-CE or the DCI, a step size indication indicating a step size for the TPCs of the multiple PRACH requests.

Aspect 12 is the method of any of aspects 4 to 11, where the method may further include resetting the accumulation of the TPCs in response to a change of the SS/PBCH index associated with the PRACH requests.

Aspect 13 is the method of any of aspects 4 to 11, where the method may further include continuing the accumulation of the TPCs in response to a change of the SS/PBCH index associated with the PRACH requests.

Aspect 14 is an apparatus for wireless communication at a UE, including: a memory; and at least one processor coupled to the memory and, based at least in part on information stored in the memory, the at least one processor is configured to perform the method of any of aspects 1-13.

Aspect 15 is the apparatus of aspect 14, further including at least one of a transceiver or an antenna coupled to the at least one processor and configured to receive the indication to transmit the PRACH transmission.

Aspect 16 is an apparatus for wireless communication including means for implementing the method of any of aspects 1-13.

Aspect 17 is a computer-readable medium (e.g., a non-transitory computer-readable medium) storing computer executable code, where the code when executed by a processor causes the processor to implement the method of any of aspects 1-13.

Aspect 18 is a method of wireless communication at a network entity. The method may include providing an indication for a UE to transmit a PRACH transmission for at least one candidate cell configured for L1/L2 inter-cell mobility; and sending, with the indication, a TPC indicating a transmit power for the PRACH transmission.

Aspect 19 is the method of aspect 18, where the method may further include providing multiple PRACH requests for the UE to transmit multiple PRACH transmissions to the at least one candidate cell. Each of the multiple PRACH requests may include a corresponding TPC and PRACH parameters. The PRACH parameters may include one or more of: a Random-Access Preamble index; a SS/PBCH index; and a PRACH mask index.

Aspect 20 is the method of aspect 19, where the multiple PRACH requests may be included in DCI.

Aspect 21 is the method of any of aspect 19 to 20, where the transmit power may be based on an accumulation of the TPCs of the multiple PRACH requests.

Aspect 22 is the method of any of aspects 19 to 21, where the method may further include providing an RRC configuration for the UE, indicating a closed loop index associated with the transmit power.

Aspect 23 is the method of any of aspects 21 to 22, where the DCI may indicate at least one of the start or the end for the accumulation of the TPCs.

Aspect 24 is the method of aspect 23, where an NDI field in the DCI may indicate the at least one of the start or the end for the accumulation. The first value of the NDI field may indicate a reset of the accumulation of the TPCs and the second value of the NDI field does not indicate the reset of the accumulation of the TPCs.

Aspect 25 is the method of any of aspects 19 to 24, where the TPCs of the multiple PRACH requests may be based on a fixed step size.

Aspect 26 is the method of any of aspects 19 to 24, where the method may further include providing, via a MAC-CE or the DCI, a step size indication indicating a step size for the TPCs of the multiple PRACH requests.

Aspect 27 is an apparatus for wireless communication at a network entity, including: a memory; and at least one processor coupled to the memory and, based at least in part on information stored in the memory, the at least one processor is configured to perform the method of any of aspects 18-26.

Aspect 28 is the apparatus of aspect 27, further including at least one of a transceiver or an antenna coupled to the at least one processor and configured to provide the indication for the UE to transmit the PRACH transmission.

Aspect 29 is an apparatus for wireless communication including means for implementing the method of any of aspects 18-26.

Aspect 30 is a computer-readable medium (e.g., a non-transitory computer-readable medium) storing computer executable code, where the code when executed by a processor causes the processor to implement the method of any of aspects 18-26.

1. An apparatus for wireless communication at a user equipment (UE), comprising:
memory; and
at least one processor coupled to the memory and, based at least in part on information stored in the memory, the at least one processor is configured to:
receive, from a serving cell, an indication to transmit a Physical Random-Access Channel (PRACH) transmission to at least one candidate cell configured for layer 1 or layer 2 (L1/L2) inter-cell mobility and a transmit power command (TPC) for the PRACH transmission; and
transmit the PRACH transmission to the at least one candidate cell using a transmit power based on the TPC.

2. (canceled)

3. The apparatus of claim 1, wherein the at least one processor is further configured to receive multiple PRACH requests indicating for the UE to transmit multiple PRACH transmissions to the at least one candidate cell, wherein each of the multiple PRACH requests includes a corresponding TPC and PRACH parameters including one or more of:
a Random-Access Preamble index;
a synchronization signal (SS)/physical broadcast channel (PBCH) (SS/PBCH) index; and
a PRACH mask index.

4. The apparatus of claim 3, wherein the multiple PRACH requests are comprised in downlink control information (DCI), and the transmit power is based on the TPC of one PRACH request of the multiple PRACH requests.

5. The apparatus of claim 3, wherein the multiple PRACH requests are comprised in downlink control information (DCI), and the transmit power is based on an accumulation of the TPCs of the multiple PRACH requests.

6. The apparatus of claim 5, wherein the accumulation of the TPCs is associated with a single closed loop index in combination for the multiple PRACH transmissions.

7. The apparatus of claim 5, wherein the accumulation of the TPCs is associated with multiple closed loop indices with a separate closed loop index for each of the multiple PRACH transmissions.

8. The apparatus of claim 7, wherein the at least one processor is further configured to:
receive a radio resource control (RRC) configuration, wherein the RRC configuration indicates a selected closed loop index of the multiple closed loop indices for the transmit power.

9. The apparatus of claim 5, wherein the DCI indicates at least one of a start or an end for the accumulation of the TPCs of the multiple PRACH requests.

10. The apparatus of claim 9, wherein a new data information (NDI) field in the DCI indicates the at least one of the start or the end for the accumulation of the TPCs, wherein a first value of the NDI field indicates a reset of the accumulation and a second value of the NDI field does not indicate the reset.

11. The apparatus of claim 5, wherein the TPCs of the multiple PRACH requests are based on a fixed step size.

12. The apparatus of claim 5, wherein the at least one processor is further configured to receive, via a medium access control-control element (MAC-CE) or the DCI, a step size indication indicating a step size for the TPCs of the multiple PRACH requests.

13. The apparatus of claim 5, wherein the at least one processor is further configured to:
reset the accumulation of the TPCs in response to a change of the SS/PBCH index associated with the PRACH requests.

14. The apparatus of claim 5, wherein the at least one processor is further configured to:
continue the accumulation of the TPCs in response to a change of the SS/PBCH index associated with the PRACH requests.

15. An apparatus for wireless communication at a network entity, comprising:
memory; and
at least one processor coupled to the memory and, based at least in part on information stored in the memory, the at least one processor is configured to:
provide an indication for a user equipment (UE) to transmit a Physical Random-Access Channel (PRACH) transmission for at least one candidate cell configured for layer 1 or layer 2 (L1/L2) inter-cell mobility; and
send, with the indication, a transmit power command (TPC) indicating a transmit power for the PRACH transmission.

16. (canceled)

17. The apparatus of claim 15, wherein the at least one processor is further configured to:
provide multiple PRACH requests for the UE to transmit multiple PRACH transmissions to the at least one candidate cell, wherein each of the multiple PRACH requests includes a corresponding TPC and PRACH parameters including one or more of:
a Random-Access Preamble index;
a synchronization signal (SS)/physical broadcast channel (PBCH) (SS/PBCH) index; and
a PRACH mask index.

18. The apparatus of claim 17, wherein the multiple PRACH requests are comprised in downlink control information (DCI).

19. The apparatus of claim 18, wherein the transmit power is based on an accumulation of the TPCs of the multiple PRACH requests.

20.-24. (canceled)

25. A method of wireless communication at a user equipment (UE), comprising:
receiving, from a serving cell, an indication to transmit a Physical Random-Access Channel (PRACH) transmission to at least one candidate cell configured for layer 1 or layer 2 (L1/L2) inter-cell mobility and a transmit power command (TPC) for the PRACH transmission; and
transmitting the PRACH transmission to the at least one candidate cell using a transmit power based on the TPC.

26. The method of claim 25, further comprising, receiving multiple PRACH requests indicating for the UE to transmit multiple PRACH transmissions to the at least one candidate cell, wherein each of the multiple PRACH requests includes a corresponding TPC and PRACH parameters including one or more of:
a Random-Access Preamble index;
a synchronization signal (SS)/physical broadcast channel (PBCH) (SS/PBCH) index; and
a PRACH mask index.

27. The method of claim 26, wherein the multiple PRACH requests are comprised in downlink control information (DCI), and the transmit power is based on the TPC of one PRACH request of the multiple PRACH requests.

28.-30. (canceled)
